(19) United States
(12) Patent Application Publication
(10) Pub. No.: US 2023/0248170 A1
(43) Pub. Date: Aug. 10, 2023

(54) Standing Desk Mat

(71) Applicant: Kevin BOHM, EI Cerrito, CA (US)

(72) Inventor: Kevin BOHM, EI Cerrito, CA (US)

(21) Appl. No.: 17/968,535

(22) Filed: Oct. 18, 2022

Related U.S. Application Data
(60) Provisional application No. 63/256,704, filed on Oct. 18, 2021.

(51) Int. Cl. A47G 27/02; B32B 5/24

(52) U.S. Cl. CPC A47G 27/0231; B32B 5/245; B32B 2266/0278; B32B 2307/7145; B32B 2307/7265; B32B 2307/7163; B32B 2471/02; B32B 2250/03; B32B 2305/022

(57) ABSTRACT

A standing desk mat comprising a multi-layered mat in which each layer comprises a different material. A cushion layer includes a soybean oil high-density memory foam pad. An example of the material comprising the cushion layer is high-density memory foam carpet cushion, a 10-pound high density frothed soybean oil and polyurethane, visco-elastic “memory foam” material. that is one hundred percent waterproof, recyclable and earth-friendly. A user-facing layer of the mat is attached to a side of the cushion layer and comprises a hand-loomed one hundred percent wool carpet. An optional non-skid layer is attached to another side of the cushion layer and configured to contact the underlying flooring.

### RELATED APPLICATION

This application claims the benefit of U.S. patent application Ser. No. 63/256,704, filed Oct. 18, 2021.

### TECHNICAL FIELD

The embodiments herein relate to desk mats and, more particularly, to standing desk mats for use while standing at a table or desk.

### BACKGROUND

A standing desk mat, also referred to herein as a desk mat or anti-fatigue mat, provides comfort and support for an individual's feet when standing on the mat, thereby allowing an individual to stand and work at a desk or table for extended periods of time. The comfort and support of a desk mat can reduce or eliminate the pain and fatigue of standing, which translates into more productivity for the individual. The widespread use of standing desk mats has produced a need for mats that are made from environmentally friendly, easy to care for materials while offering to the user the highest levels of comfort and support.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1A is a block diagram of a top-down view of a bottom of a standing desk mat, under an embodiment.

FIG. 1B is a block diagram of a side view of the standing desk mat, under an embodiment.

FIG. 1C is an exploded diagram of an example of the standing desk mat, under an alternative embodiment.

FIG. 1D is a flow diagram for an example process for generating the standing desk mat, under the alternative embodiment.

FIG. 2 is a top-down view of a bottom of the standing desk mat, under an embodiment.

FIG. 3 is top-down view of a corner detail of the bottom of the standing desk mat, under an embodiment.

FIG. 4 is a side perspective view of the bottom of the standing desk mat, under an embodiment.

FIG. 5 is a top-down view of a top of the standing desk mat, under an embodiment.

FIG. 6 is a side perspective view of the top of the standing desk mat under an embodiment.

### DETAILED DESCRIPTION

A standing desk mat is described comprising a multi-layered mat in which each layer comprises a different material. A cushion layer includes a soybean oil high-density memory foam pad. An example of the material comprising the cushion layer is high-density memory foam carpet cushion, a 10-pound high density frothed soybean oil and polyurethane, visco-elastic “memory foam” material, that is one hundred percent waterproof, recyclable and earth-friendly. A user-facing layer of the mat is attached to a side of the cushion layer and comprises a hand-loomed one hundred percent wool carpet. An optional non-skid layer is attached to another side of the cushion layer and configured to contact the underlying flooring.

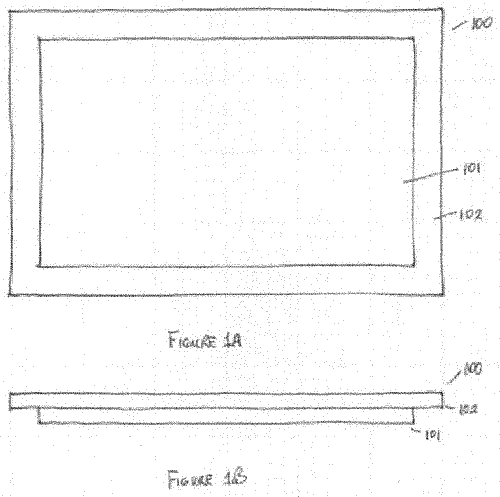

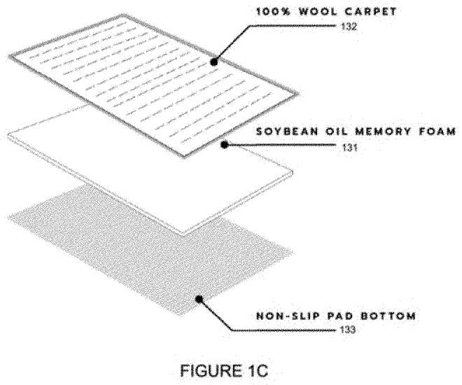

Embodiments described herein include a desk mat comprising a soybean oil memory foam pad, also referred to herein as a standing desk mat. The standing desk mat 5 of an embodiment comprises a multi-layer mat in which each layer is formed to include a different material. FIG. 1A is a block diagram of a top-down view of a bottom of a standing desk mat 100, under an embodiment. FIG. 1B is a block diagram of a side view of the standing desk mat 100, under an embodiment. The standing desk mat described as an example herein is rectangular in shape with dimensions comprising a width of approximately 37 inches, a depth of approximately 25 inches, and a total thickness of approximately one (1) inch. While the standing desk mat example described herein has a specified shape and dimensions, the standing desk mats are not so limited and can be formed, to include any of a number of shapes (e.g. square, circle, elliptical, kidney, etc.) and/or dimensions.

The standing desk mat 100 of an example embodiment includes a first component 101, also referred to herein as the bottom component 101, coupled or connected to a second component 102, also referred to herein as the top component 102. While this example includes a two-layer desk mat, alternative embodiments can include any number of layers. The bottom 101 component of an embodiment has smaller dimensions than its corresponding top 102 component, however the bottom component 101 of alternative embodiments can have similar dimensions to those of the corresponding top component 102.

The bottom 101 and top 102 components are coupled or connected using one or more techniques known and used in the art in the flooring installation industry. By way of example, the bottom 101 and top 102 components can be coupled or connected using at least one of adhesive, bonding, welding, taping, stitching, stapling, fusing, and webbing to name a few.

The bottom component 101 of the standing mat 100 of this example, which is configured to be placed on the floor in front of a standing desk or table, comprises a cushion component 101. The bottom component 101 is configured to have a thickness in a range of approximately one-quarter inch to one-half inch but is not limited to a thickness in this approximate range. The bottom component 101 of an example embodiment comprises a soybean oil high-density memory foam cushion or pad but is not so limited.

More particularly, an example of the material used for the bottom component 101 of an embodiment is Healthier Choice® 100% High Density Memory Foam Carpet Cushion available from Healthier Choice Flooring LLC, Dalton, Ga. The Healthier Choice® memory foam is a 10-pound high density frothed soybean oil and polyurethane, visco-elastic “memory foam” material, that is one hundred percent waterproof, recyclable and earth-friendly. Additionally, the Healthier Choice® memory foam comprises Ultra Fresh® antimicrobial to prevent mold, mildew, and bacterial growth. Further, the Healthier Choice® memory foam is the only foam cushion GREENGUARD Indoor Air Quality Certified® as a low-emitting interior building material, so its use therefore can improve indoor air quality.

The top component 102 of the standing desk mat 100 of an example embodiment, which is configured to face the user when positioned in front of a standing desk or table, comprises a fabric component 102. The fabric component 102 is configured to have a thickness in a range of approximately one-quarter inch to one-half inch but is not limited to a thickness in this approximate range. The fabric component 102 comprises a wool fabric for example but is not so limited. More particularly, an example of the material used for the top component 102 of an embodiment comprises a hand-loomed one hundred percent wool carpet, an example of which is Colony carpet by Hibernia Woolen Mills and available from Stanton Carpet Corporation, Calhoun, Ga.

FIG. 1C is an exploded diagram of an example of the standing desk mat 130, under an alternative embodiment. As described herein, the bottom component 131 of the standing mat 130 of this example comprises a cushion component 131. The bottom component 131 is configured to have a thickness in a range of approximately one-quarter inch to one-half inch but is not limited to a thickness in this approximate range. The bottom component 131 of an example embodiment comprises a soybean oil high-density memory foam cushion or pad, for example, the Healthier Choice® 100% High Density Memory Foam Carpet Cushion, but the embodiment is not so limited.

The top component 132 of the standing desk mat 130 of this example comprises a fabric component 132. The fabric component 132 is configured to have a thickness in a range of approximately one-quarter inch to one-half inch but is not limited to a thickness in this approximate range. The fabric component 132 comprises a wool fabric, for example, a one hundred percent wool carpet, but embodiments are not so limited.

The standing desk mat 130 of this example embodiment also includes an additional component 133 coupled or connected to a bottom side of the bottom component 131. The additional component 133 comprises a pad bottom 133 configured to be placed in contact with the floor, for example a non-slip pad bottom, but is not so limited.

FIG. 1D is a flow diagram for an example process for generating the standing desk mat 130, under the alternative embodiment. The process includes cutting the top or fabric component 132 to a desired size (e.g., 24 inches by 36 inches) 141, and cutting the bottom or cushion component 131 to the desired size (e.g., 24 inches by 36 inches) 142. A non-skid mat is cut to a desired size (e.g., 24 inches by 36 inches) 143 to be used as the additional bottom component 133. The fabric component 132 is bound 144. and the bottom component 131 is attached (e.g., glued) 145 to the fabric component 132, The process continues by serging the fabric component 132 with the non-skid mat 133.

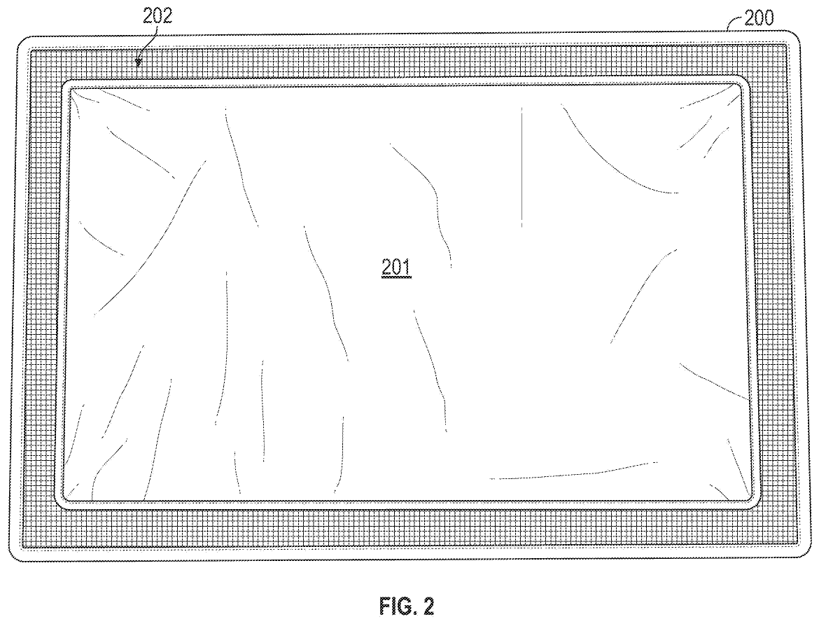

FIG. 2 is a top-down view of the bottom of the standing desk mat 200, under an embodiment. The bottom component 201 of the standing desk mat 200 comprises the Healthier Choice® 100% High Density Memory Foam Carpet Cushion, and the top component 202 comprises the Colony wool carpet as described in detail herein. The bottom 201 and/or top 202 components each include an edge or finishing treatment around the perimeters but are not so limited. The bottom 201 and top 202 components of embodiments herein include serged edges around the respective perimeters for example, but alternative embodiments can include bound edges or other edge treatments.

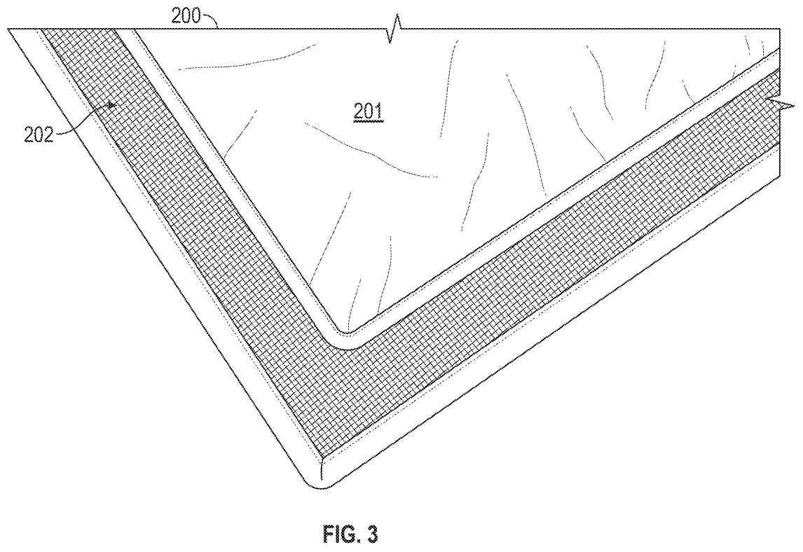

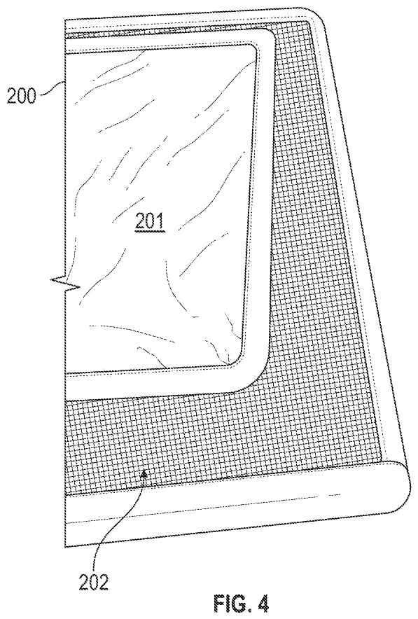

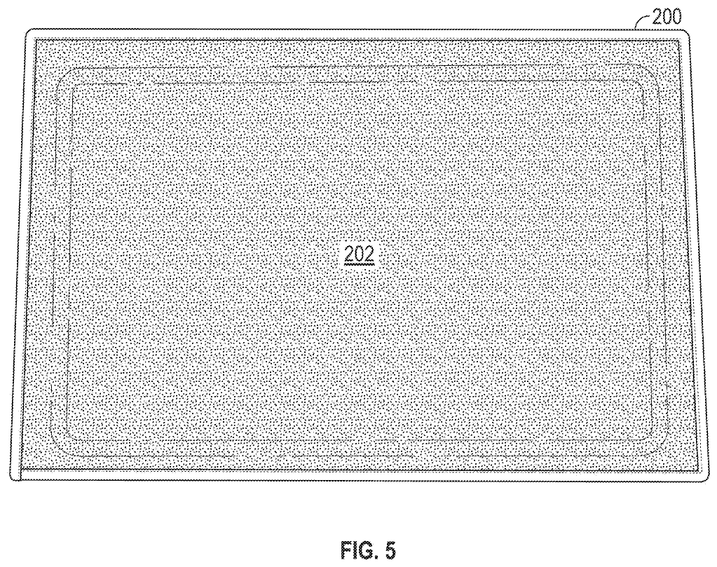

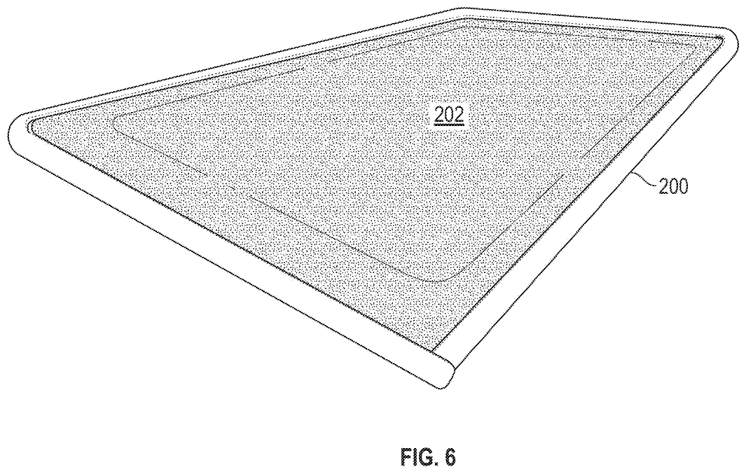

Additional figures show different views of the standing desk mat 200 of this example embodiment. FIG. 3 is top-down view of a corner detail of the bottom of the standing desk mat 200, under an embodiment. FIG. 4 is a side perspective view of the bottom of the standing desk mat 200, under an embodiment. FIG. 5 is a top-down view of a top of the standing desk mat 200, under an embodiment. FIG. 6 is a side perspective view of the top of the standing desk mat 200. under an embodiment.

Embodiments include a device comprising a first component including a cushion comprising high-density memory foam, a second component including a fabric comprising a natural material, wherein the second component is attached to a first side of the first component and is configured as a user-facing layer of a standing desk mat, and a third component including a non-skid material, wherein the third component is attached to a second side of the first component and configured to contact underlying flooring, wherein the second, side of the first component is opposite the first side of the first component.

The first component comprises a soybean oil memory foam.

The first component comprises a soybean oil and polyurethane visco-elastic material.

The first component comprises 10-pound high-density material.

The first component is waterproof.

The first component is recyclable.

The first component, comprises an antimicrobial.

The fabric comprises pure wool carpet.

Embodiments include a device comprising a first component including a cushion comprising high-density memory foam, and a second component including a fabric comprising a natural material, wherein the second component is attached to a first side of the first component and is configured as a user-facing layer of a standing desk mat.

A second side of the first component is opposite the first side of the first component and configured to contact underlying flooring.

The first component comprises a soybean oil and polyurethane visco-elastic material.

The first component is waterproof and recyclable.

The fabric comprises pure wool carpet.

The device comprises a third component including a non-skid material, wherein the third component is attached to a second side of the first component and configured to contact underlying flooring, wherein the second side of the first component is opposite the first side of the first component.

Embodiments include a method comprising forming a cushion component to include high-density memory foam, forming a fabric component to include a natural material, attaching the fabric component to a first side of the cushion component as a user-facing layer of a standing desk mat, forming a non-skid component configured to contact underlying flooring, and attaching the non-skid component to a second side of the cushion component.

The forming the cushion component comprises forming the cushion component to include a soybean oil memory foam.

The forming the cushion component comprises forming the cushion component to include a soybean oil and polyurethane visco-elastic material.

The forming the cushion component comprises forming the cushion component to include a 10-pound high-density material.

The forming the cushion component comprises forming the cushion component as waterproof.

The forming the fabric component comprises forming the fabric component from pure wool carpet.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the devices and methods to the precise forms disclosed. While specific embodiments of, and examples for, the devices and methods are described herein for illustrative purposes, various equivalent modifications are possible within the scope of the devices and methods, as those skilled in the relevant art will recognize. The teachings of the devices and methods provided herein can be applied to other devices and methods, not only for the devices and methods described above.

The elements and acts of the various embodiments described above can be combined to provide further embodiments. These and other changes can be made to the devices and methods in light of the above detailed description.

In general, in the following claims, the terms used should not be construed to limit the devices and methods to the specific embodiments disclosed in the specification and the claims but should be construed to include all devices and methods that operate under the claims. Accordingly, the devices and methods are not limited by the disclosure, but instead the scope is to be determined entirely by the claims.

While certain aspects of the devices and methods are presented below in certain claim forms, the inventors contemplate the various aspects of the devices and methods in any number of claim forms. Accordingly, the inventors reserve the right to add additional claims after filing the application to pursue such additional claim forms for other aspects of the devices and methods.

What is claimed is:

1. A device comprising:
a first component including a cushion comprising high-density memory foam;
a second component including a fabric comprising a natural material, wherein the second component is attached to a first side of the first component and is configured as a user-facing layer of a standing desk mat; and
a third component including a non-skid material, wherein the third component is attached to a second side of the first component and configured to contact underlying flooring, wherein the second side of the first component is opposite the first side of the first component.

2. The device of claim I, wherein the first component comprises a soybean oil memory foam.

3. The device of claim 2, wherein the first component comprises a soybean oil and polyurethane visco-elastic material.

4. The device of claim 2, wherein the first component comprises 10-pound high-density material.

5. The device of claim 1, wherein the first component comprises an antimicrobial and is waterproof.

6. The device of claim 1, wherein the first component is recyclable.

7. The device of claim I, wherein the fabric comprises pure wool carpet.

8. A device comprising:
a first component including a cushion comprising high-density memory foam; and
a second component including a fabric comprising a natural material, wherein the second component is attached to a first side of the first component and is configured as a user-facing layer of a standing desk mat.

9. The device of claim 8, wherein a second side of the first component is opposite the first side of the first component and configured to contact underlying flooring.

10. The device of claim 8, wherein the first component comprises a soybean oil and polyurethane visco-elastic material.

11. The device of claim 8, wherein the first component is waterproof and recyclable.

12. The device of claim 8, wherein the fabric comprises pure wool carpet.

13. The device of claim 8, comprising a third component including a non-skid material, wherein the third component is attached to a second side of the first component and configured to contact underlying flooring, wherein the second side of the first component is opposite the first side of the first component.

14. A method comprising:
forming a cushion component to include high-density memory foam;
forming a fabric component to include a natural material;
attaching the fabric component to a first side of the cushion component as a user-facing layer of a standing desk mat;
forming a non-skid component configured to contact underlying flooring; and
attaching the non-skid component to a second side of the cushion component.

15. The method of claim 14, wherein the forming the cushion component comprises forming the cushion component to include a soybean oil memory foam.

16. The method of claim 14, wherein the forming the cushion component comprises forming the cushion component to include a soybean oil and polyurethane visco-elastic material.

17. The method of claim 14, wherein the forming the cushion component comprises forming the cushion component to include a 10-pound high-density material.

18. The method of claim 14, wherein the forming the cushion component comprises forming the cushion component as waterproof.

19. The method of claim 14, wherein the forming the fabric component comprises forming the fabric component from pure wool carpet.

20. A standing mat comprising:
a cushion including a soybean oil memory foam; and
a fabric component comprising a natural material, wherein the fabric component is attached to a first side of the cushion and is configured as a user-facing layer of the mat.
